(19) United States
(12) Patent Application Publication
(10) Pub. No.: US 2014/0253459 A1
(43) Pub. Date: Sep. 11, 2014

(54) CHIP-ON-GLASS FOR TOUCH APPLICATIONS

(71) Applicant: Maxim Integrated Products, Inc., (US)

(72) Inventors: Ronald B. Koo, Los Altos, CA (US); Ronald S. Lee, San Francisco, CA (US)

(73) Assignee: MAXIM INTEGRATED PRODUCTS, INC., San Jose, CA (US)

(21) Appl. No.: 13/786,564

(22) Filed: Mar. 6, 2013

(51) Int. Cl. G06F 3/041

(52) U.S. Cl. CPC G06F 3/041
USPC 345/173; 29/622

(57) ABSTRACT

A touch panel assembly device implementing chip-on-glass technology and a method (e.g., process) for making same are described herein. The touch panel assembly includes a touch panel (e.g., a capacitive touch panel). The touch panel includes a substrate formed of insulator material (e.g., glass). The touch panel also includes a plurality of conductors (e.g., transparent conductors, indium tin oxide traces) formed on the substrate. The touch panel assembly further includes an integrated circuit (e.g., a touch chip). The integrated circuit is disposed upon the substrate and is connected (e.g.., mechanically and electrically connected) to one or more conductors included in the plurality of conductors. The integrated circuit is communicatively coupled with the touch panel.

### BACKGROUND

A touch panel is a human-machine interface (HMI) that allows an operator of an electronic device to provide input to the device using an instrument such as a finger, a stylus, and so forth. For example, the operator may use his or her finger to manipulate images on an electronic display, such as a display attached to a mobile computing device, a personal computer (PC), or a terminal connected to a network. In some cases, the operator may use two or fingers simultaneously to provide unique commands, such as a zoom command, executed by moving two fingers away from one another, a shrink command, executed by moving two fingers toward one another; and so forth.

A touch screen is an electronic visual display that incorporates a touch panel overlying a display to detect the presence and/or location of a touch within the display area of the screen. Touch screens are common in devices such as all-in-one computers, mobile computing devices (e.g., handheld portable computers, Personal Digital Assistants (PDAs), laptop computers, notebook computers, tablet computers, and so forth), mobile telephone devices (e.g., cellular telephones and smartphones), portable game devices, portable media players, multimedia devices, satellite navigation devices (e.g., Global Positioning System (GPS) navigation devices), e-book reader devices (eReaders), Smart Television (TV) devices, surface computing devices (e.g., table top computers), Personal Computer (PC) devices, and so forth. A touch screen enables an operator to interact directly with information that is displayed by the display underlying the touch panel, rather than indirectly with a pointer controlled by a mouse or touchpad. Capacitive touch panels are often used with touch screen devices. A capacitive touch panel generally includes an insulator, such as glass, coated with a transparent conductor, such as indium tin oxide (ITO). As the human body is also an electrical conductor, touching the surface of the panel results in a distortion of the panel's electrostatic field, measurable as a change in capacitance.

### SUMMARY

A touch panel assembly device implementing chip-on-glass technology and a method (e.g., process) for making same are described herein. The touch panel assembly includes a touch panel (e.g., a capacitive touch panel). The touch panel includes a substrate formed of insulator material (e.g., glass). The touch panel also includes a plurality of conductors (e.g., transparent conductors, indium tin oxide traces) formed on the substrate. The touch panel assembly further includes an integrated circuit (e.g., a touch chip). The integrated circuit is disposed upon the substrate and is connected (e.g.., mechanically and electrically connected) to one or more conductors included in the plurality of conductors. The integrated circuit is communicatively coupled with the touch panel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The detailed description is described with reference to the accompanying figures. The use of the same reference numbers in different instances in the description and the figures may indicate similar or identical items.

FIG. 1 is a diagrammatic illustration of a touch panel assembly including a touch panel controller (e.g., application processor) in accordance with exemplary embodiment of the present disclosure.

FIG. 2 is a diagrammatic illustration of a touch panel controller in accordance with an exemplary embodiment of the present disclosure.

FIG. 3 is an exploded isometric view illustrating a touch panel assembly incorporating a capacitive touch panel with drive and sensor layers, where the drive and sensor layers are sandwiched between a display screen and a bonding layer with a protective cover attached thereto in accordance with an exemplary embodiment of the present disclosure.

FIG. 4 is a cross-sectional view illustrating the connection of the touch chip to the touch panel of the touch panel assembly in accordance with an exemplary embodiment of the present disclosure.

FIG. 5 is a top plan schematic view of a touch panel shown connected to a flexible printed circuit board, the touch panel having a single touch chip (chip-on-glass (COG) chip) for signal transmission and signal reception in accordance with an embodiment of the present disclosure.

FIG. 6 is a diagrammatic illustration showing the connection of the touch panel (which includes the touch chip), the flexible printed circuit board, and a main printed circuit board (which includes the controller) in accordance with an exemplary embodiment of the present disclosure.

FIG. 7 is a top plan schematic view of a 1.5-layer touch panel (e.g., a 6-inch to 10-inch touch panel) shown connected to a flexible printed circuit board, the touch panel having separate touch chips (e.g., chip-on-glass (COG) chips) for signal transmission and signal reception in accordance with an exemplary embodiment of the present disclosure.

FIG. 8 is a top plan schematic view of a 1.5-layer touch panel (e.g., a 10-inch to 15-inch touch panel) shown connected to a flexible printed circuit board, the touch panel having separate touch chips (e.g., chip-on-glass (COG) chips) for signal transmission and signal reception in accordance with a further exemplary embodiment of the present disclosure.

FIG. 9 depicts a flow diagram illustrating an example process for fabricating a touch panel assembly in accordance with an exemplary embodiment of the present application.

### DETAILED DESCRIPTION

### Overview

A number of currently available electronic devices (e.g., mobile phones) include a main printed circuit board, a touch sensor (e.g., touch sensor panel, touch sensor substrate, touch panel), and a flexible printed circuit board, the flexible printed circuit board connecting the main printed circuit board to the touch panel. With these currently available electronic devices, the number of electrical connections on the touch panels are increasing due to the following: i) bigger screen sizes; ii) a shift from double-layer touch panels to single layer touch panels; iii) a trend towards zero border design; and iv) passive stylus support (increases the density of the indium tin oxide (ITO) lines. With some of the currently available devices, the metal layers on the flexible printed circuit board are increasing from 1 to 2 to support the transmitter/receiver signal crossings that need to be made for true single layer touch sensors.

Further, the currently available electronic devices implement a touch chip by either: i) disposing the touch chip upon the flexible printed circuit board; or ii) disposing the touch chip upon the main printed circuit board. In both scenarios, the flexible printed circuit board is required to have a large number of electrical connections (inputs/outputs (I/Os)) because all of the electrical connections come from the touch chip and must pass through the flexible printed circuit board. Because the width of the flexible printed circuit board is directly proportional to the number of electrical connections (I/Os) that must pass through it, the widths of the flexible printed circuit boards in these currently available electronic devices are increasing. This results in increased costs and complexity of producing the flexible printed circuit board, along with decreased attachment yield.

Described herein is a touch panel assembly and method for producing same in which chip-on-glass (COG) technology is implemented for promoting reduced size (e.g., width), cost and complexity of the flexible printed circuit board implemented in the touch panel assembly. In the touch panel assembly of the present disclosure, the touch chip and its large number of electrical connections are moved from the flexible printed circuit board to the touch panel itself, thereby reducing the cost of large touch solutions, true single ITO solutions, and borderless touch sensor panels (at least on 3 sides). The touch panel assembly of the present disclosure provides greater freedom in industrial design because the width of the flexible printed circuit board can be dramatically reduced, thereby allowing for easier connection of the flexible printed circuit board (and the touch panel) to the main printed circuit board. The touch panel assembly of the present disclosure, by having the touch chip on the touch panel, promotes better signal quality compared to the currently available devices (which have the touch chip on the flexible printed circuit board or the main printed circuit board). Implementing COG technology in touch panel assemblies as described herein can result in touch chips that sense the mutual capacitance and self-capacitance of the touch panel. Further, implementing COG technology in touch panel assemblies as described herein can dramatically decrease the number of lines (e.g., electrical connections/traces) necessary to be routed around the corner and along a bezel, thereby promoting adherence to zero border design trends.

### Example Implementations

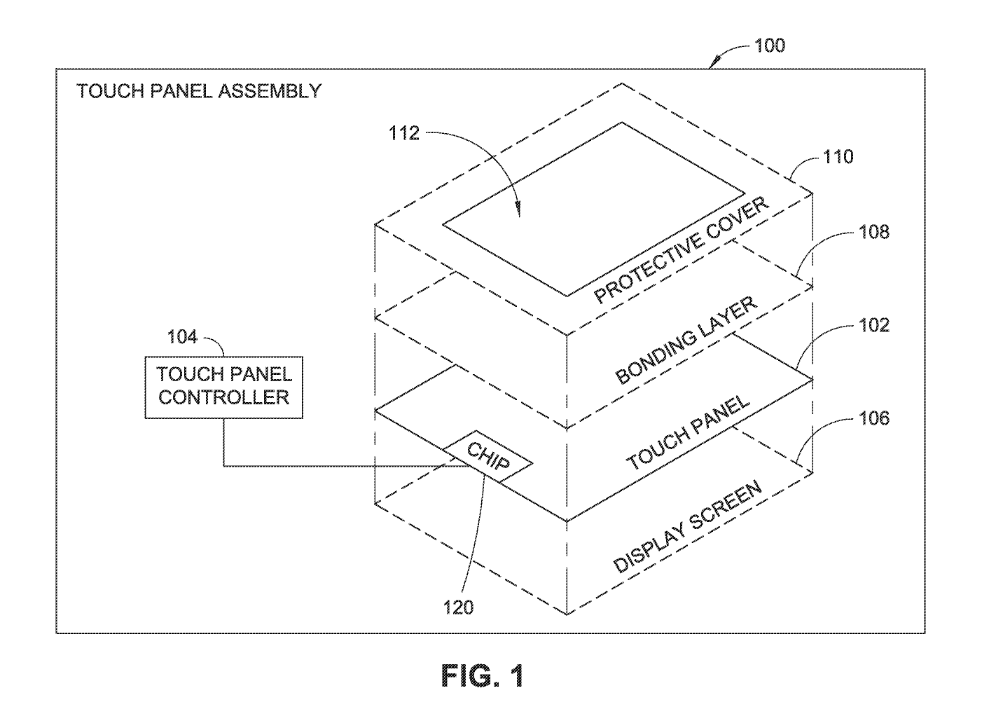

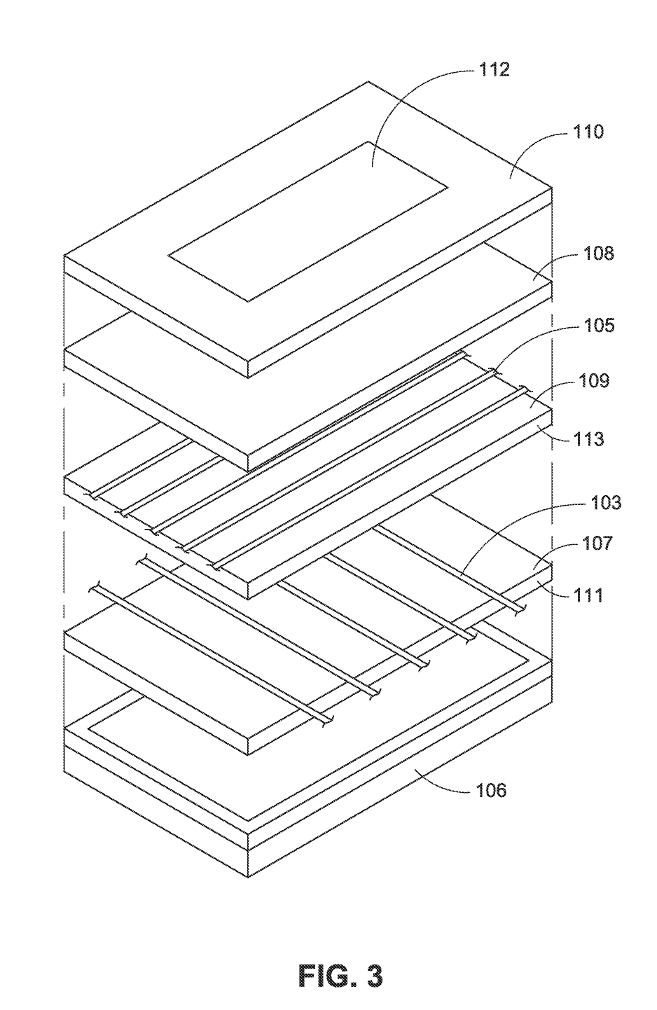

FIGS. 1 and 3 illustrate an example touch panel assembly 100 configured for receiving and interpreting input from an instrument such as a finger, a stylus, and so forth. A touch panel assembly 100 includes a touch panel 102 coupled with a touch panel controller 104 (e.g., application processor) for controlling the touch panel 102. In implementations, a touch panel 102 may comprise a mutual capacitance-based capacitive touch panel, such as a Projected Capacitive Touch (PCT) panel. Although the illustrated embodiments in FIGS. 1 and 3 show the touch panel assembly 100 and touch panel 102 as being a capacitive touch panel assembly and capacitive touch panel, it is contemplated that in other embodiments, the touch panel assembly 100 and touch panel 102 can be any one of various touch panel assemblies/touch panels, such as a resistive touch panel assembly/resistive touch panel, a surface acoustic wave touch panel assembly/surface acoustic wave touch panel, and so forth.

In embodiments, the touch panel 102 may include cross-bar X and Y indium tin oxide (ITO) patterns used for drive electrodes/drive traces 103 and sensor electrodes/sensor traces 105. The drive electrodes 103 and sensor electrodes 105 correspond to a coordinate system, where each coordinate location (e.g., pixel) comprises a capacitor formed at an intersection between a drive electrode 103 and a sensor electrode 105.

The drive electrodes 103 are connected to a voltage source to generate a local electrostatic field at each capacitor, and a change in the local electrostatic field generated by the touch of an instrument (e.g., a finger, a stylus) at each capacitor causes a change in capacitance at the corresponding coordinate location/pixel. In some cases, more than one touch can be sensed at different coordinate locations simultaneously. In implementations, the pitch, or substantially repetitive spacing between adjacent longitudinal axes of the drive electrodes and sensor electrodes (e.g., ITO spacing), may be approximately five millimeters (5 mm) to provide touch accuracy for the touch of one or more fingers.

The cross-bar patterns can be formed using two (2) layers (e.g., a drive layer 107 and a sensor layer 109) or 1.5-layers (e.g., drive and sensor electrodes on a single layer, with jumpers connecting portions of the drive and/or sensor electrodes together). The sensor electrodes are electrically insulated from the drive electrodes (e.g., by using a dielectric layer, and so forth). For example, the drive electrodes 103 may be provided on a one substrate (e.g., comprising a drive layer 107 disposed on glass substrate 111), the sensor electrodes 105 may be provided on another substrate (e.g., comprising a sensor layer 109 disposed on a separate substrate 113). In this two-layer configuration, the sensor layer 109 can be disposed above the drive layer 107 (e.g., with respect to the touch surface 112). For example, the sensor layer 109 can be positioned closer to the touch surface 112 than the drive layer 107. However, this configuration is provided by way of example only and is not meant to be restrictive of the present disclosure. Thus, other configurations can be provided where the drive layer is positioned closer to the touch surface 112 than the sensor layer, and/or where the sensor layer and the drive layer comprise the same layer. For instance, in a 1.5-layer implementation (e.g., where the drive layer and the sensor layer are included on the same layer, but are physically separated from one another), one or more jumpers can be used to connect portions of a drive electrode together. Similarly, jumpers can be used to connect portions of a sensor electrode together.

One or more touch panels 102 can be included with a touch panel assembly 100 implemented as a touch screen assembly. A touch screen assembly may include a display screen 106, such as a liquid crystal display (LCD) screen, where the sensor layer and the drive layer of the touch panel 102 are sandwiched between the display screen 106 and a bonding layer 108, the bonding layer 108 having a protective cover 110 (e.g., glass) attached thereto. The protective cover 110 may include a protective coating, an anti-reflective coating, and so forth. The protective cover 110 may comprise a touch surface 112, upon which an operator can use a touch instrument (e.g., one or more fingers, a stylus, and so forth) to input commands to the touch screen assembly. For example, the touch panel 102 may be operatively configured for allowing an operator of the touch panel 102 to use a writing accessory, such as a stylus, which includes a generally pointed end having a smaller diameter than a finger. The commands can be used to manipulate graphics displayed by, for example, the LCD screen 106. Further, the commands can be used as inputs to an electronic device connected to the touch panel 102, such as a multimedia device or another electronic device (e.g., as previously described).

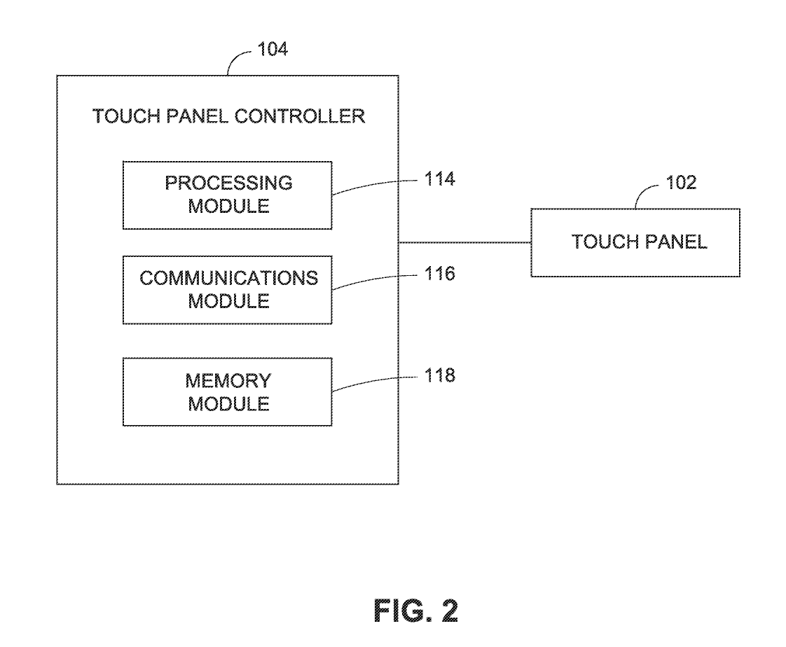

Referring now to FIG. 2, the touch panel controller 104 may include a processing module 114, a communications module 116, and a memory module 118. The processing module 114 provides processing functionality for the touch panel controller 104 and may include any number of processors, micro-controllers, or other processing systems and resident or external memory for storing data and other information accessed or generated by the touch panel controller 104. The processing module 114 may execute one or more software programs. The processing module 114 is not limited by the materials from which it is formed or the processing mechanisms employed therein, and as such, may be implemented via semiconductor(s) and/or transistor(s) (e.g., using electronic Integrated Circuit (IC) components), and so forth. The communications module 116 is operatively configured for communicating with components of the touch panel 102. For example, the communications module 116 can be configured for controlling the drive electrodes 103 of the touch pad 102, receiving inputs from the sensor electrodes 105 of the touch panel 102, and so forth. The communications module 116 is also communicatively coupled with the processing module 114 (e.g., for communicating inputs from the sensor electrodes 105 of the touch panel 102 to the processing module 114).

The memory module 118 is an example of tangible computer-readable media that provides storage functionality to store various data associated with operation of the touch panel controller 104, such as software programs and/or code segments, or other data to instruct the processing module 114 and possibly other components of the touch panel controller 104 to perform functions. Although a single memory module 118 is shown, a wide variety of types and combinations of memory may be employed. The memory module 118 may be integral with the processing module 114, may comprise stand-alone memory, or may be a combination of both. The memory module 118 may include, but is not necessarily limited to: removable and non-removable memory components, such as Random Access Memory (RAM), Read-Only Memory (ROM), Flash memory (e.g., a Secure Digital (SD) memory card, a mini-SD memory card, a micro-SD memory card), magnetic memory, optical memory, Universal Serial Bus (USB) memory devices, and so forth.

As shown in FIG. 1, the touch panel assembly 100 further includes one or more touch chips 120. In embodiments, the touch chip 120 is disposed upon (e.g., is directly connected to) the touch panel 102. For example, the touch chip 120 is located near the perimeter (e.g., edges) of the touch panel 102. The touch chip 120 is an integrated circuit (IC). For example, the touch chip 120 comprises a set of electronic circuits formed on a small plate (e.g., chip) of semiconductor material (e.g., silicon). The touch chip 120 is communicatively coupled with the touch panel 102. In embodiments, the touch chip 120 is connected to (e.g., communicatively coupled with) the touch panel controller 104. For example, the touch chip 120 is configured for receiving signals from and/or transmitting signals to the controller 104 and/or the touch panel 102 for promoting the above-described functionality of the touch panel assembly 100.

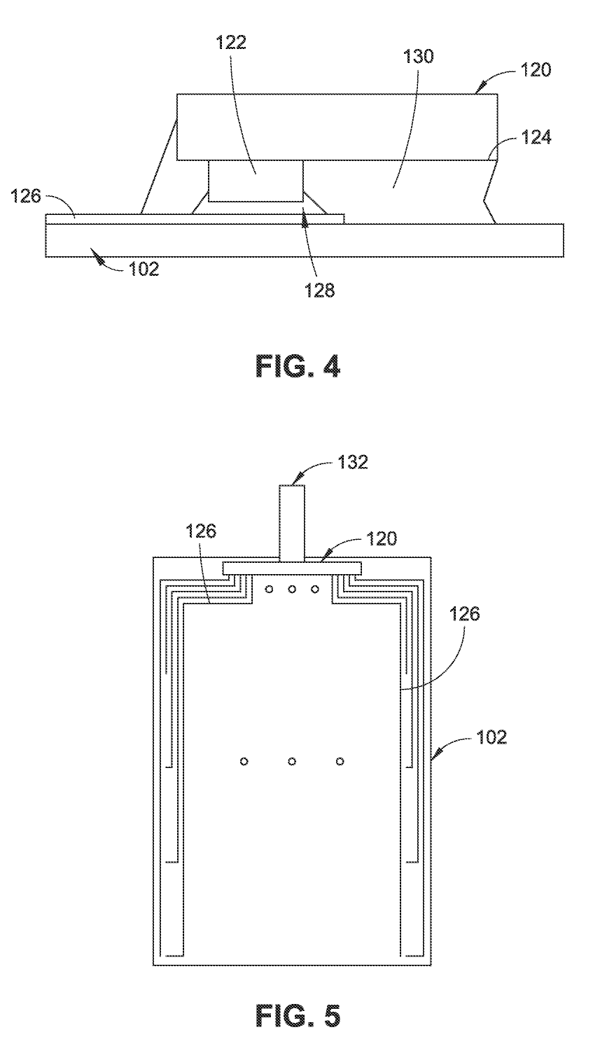

As mentioned above, the touch chip 120 is connected to (e.g., directly disposed upon and communicatively coupled with) touch panel 102. FIG. 4 illustrates the connection of the touch chip 120 to the touch panel 102. In embodiments, the touch chip 120 includes a plurality of connectors (e.g., bump assemblies, bumps, gold bumps) 122 disposed on connecting pads formed on a surface 124 of the touch chip 120. In embodiments, the touch chip 120 is connected to (e.g., disposed upon, bonded to) connectors/traces (e.g., ITO tracks) 126 formed upon the touch panel 102. In embodiments, the gold bumps 122 of the touch chip are bonded to the ITO traces 126 on the touch panel 102 for electrically and mechanically connecting the touch chip 120 to the touch panel 102. In embodiments, the gold bumps 122 are bonded to the ITO traces 126 via a conductive adhesive 128, which may be cured via heating (e.g., a thermoset adhesive), or may be cured via ultraviolet (UV) light (e.g., a thermoplastic adhesive). In embodiments, the conductive adhesive is Anisotropic Conductive Film (ACF) 128. ACF 128 is a thermosetting epoxy which contains electrically conductive particles. During curing, these particles of the ACF 128 are trapped between the bumps 122 and the ITO traces 126 to provide electrical conductivity. Further, the adhesive matrix provided by ACF 128 provides electrical insulation and promotes stable adhesion between the tracks 126 and the bumps 122. In embodiments, pressure and heat are applied to promote bonding of the touch chip 120 (via its gold bumps 122) to the ITO tracks 126 of the touch panel 102 via the ACF 128. Further, an underfill 130 (e.g., an epoxy underfill) may be applied between the touch chip 120 and the touch panel 102 (e.g., the glass) for promoting the stability of the connection of the touch chip 120 to the touch panel 102. In embodiments, the touch chip 120 may be configured as an elongated narrow structure with many bumps 122 for reducing the footprint occupied by the touch chip 120 on the touch panel 102.

FIG. 5 shows a top plan schematic view of the touch panel 102 in which a single touch chip 120 is connected to the tracks 126 of the touch panel 102 in accordance with an embodiment of the present disclosure. As mentioned above, the touch chip 120 may be connected to (e.g., communicatively coupled with) the touch panel controller 104. In embodiments, the touch panel controller 104 may be connected to (e.g., disposed upon) a main circuit board (e.g., a main printed circuit board) 134, the main printed circuit board 134 having electrical connections. Further, the main printed circuit board 134 is connected to the touch panel 102 and the touch chip 120 via a flexible printed circuit board 132. In embodiments, the touch chip 120 on the touch panel 102 is connected to (e.g., physically and electrically connected to) the flexible printed circuit board 132. In embodiments, the touch panel 102 may be connected to (e.g., communicatively coupled with, electrically connected with) the controller 104, the main printed circuit board 134, and the flexible printed circuit board 132 via the touch chip 120. Because the touch chip 120 is bonded directly to the touch panel 102, the electrical connections (e.g., tracks) 126 go straight to the chip 120 and never have to pass through the flexible printed circuit board 132. Consequently, the electrical connections on the flexible printed circuit board 132 of the present disclosure are reduced compared to flexible printed circuit boards used in currently implemented touch panel assembly configurations. In embodiments, the electrical connections on the flexible printed circuit board 132 can be a small number (e.g., twelve) of connections. For example, the electrical connections on the flexible printed circuit board 132 can be limited to only serial digital interface connections and power supply connections. In embodiments, the touch panel assembly 100 of the present disclosure allows for a large number of transmitter/receiver signal crossings to be located in the touch chip 120, rather than on the flexible printed circuit board 132. The touch chip 120 can be configured to easily accommodate this due to the multiple layers of metal available on a modern IC process.

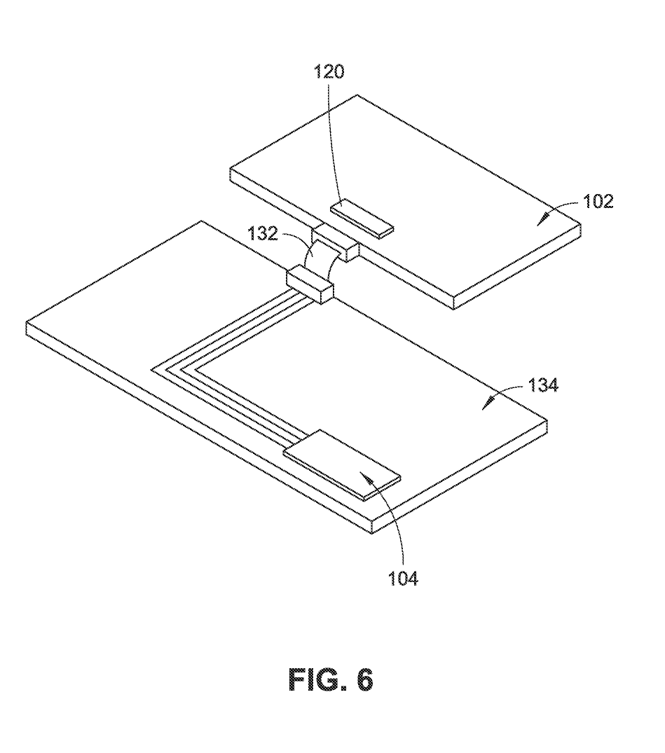

FIG. 6 is a diagrammatic illustration showing the connection between the touch chip 120 (disposed on the touch panel 102) and the controller 104 (disposed on the main printed circuit board 134), the touch pad 102 and main printed circuit board 134 being connected via the flexible printed circuit board 132.

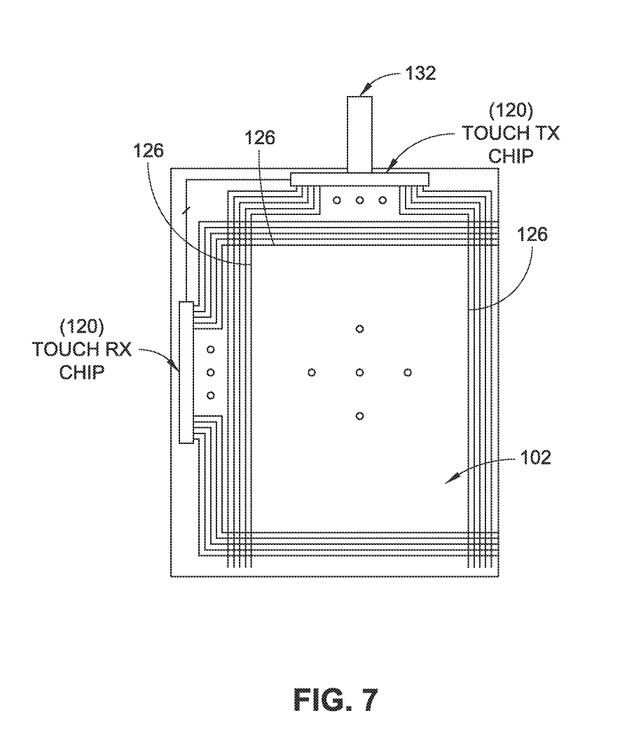

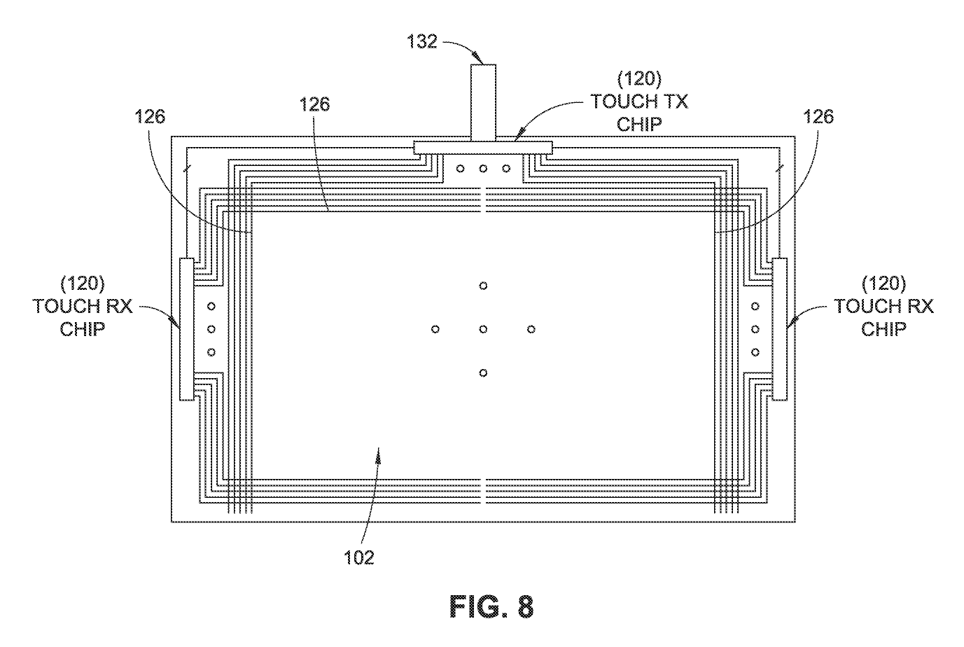

Larger touch panels may have a larger number of electrical connections. For these larger touch panels, multiple touch chips (e.g., chip-on-glass (COG) chips) 120 can be used in order to reduce the length of the electrical connections 126 of the touch panels and to reduce the width of the borders of the touch panels. FIGS. 7 and 8 show top plan schematic views of touch panels 102 in which multiple touch chips 120 are disposed upon the touch panels 102 and connected to (e.g., electrically connected to) the tracks (e.g., electrical connections) 126 of the touch panels 102 in accordance with further exemplary embodiments of the present disclosure. In the two-chip embodiment shown in FIG. 7, one touch chip 120 is configured as the transmitter (TX) chip, while the other touch chip is configured as the receiver (RX) chip. The TX chip is configured for containing transmitters, while the RX chip is configured for containing receivers. Further, in the embodiment shown in FIG. 7, the chip 120 of the touch panel 102 which is connected to the flexible printed circuit board 132 and communicatively coupled with the controller 104 (e.g., the TX chip) is configured for sending control signals and power signals to the other chip (e.g., the RX chip) of the two chips 120. In the three-chip embodiment shown in FIG. 8, one touch chip is configured as the TX chip, while the other two chips are configured as RX chips. However, in other embodiments, the reverse could be true, such that one chip is the RX chip and the other two chips are TX chips. Further, in the embodiment shown in FIG. 8, the chip 120 of the touch panel 102 which is connected to the flexible printed circuit board 132 and communicatively coupled with the controller 104 (e.g., the TX chip) is configured for sending control signals and power signals to the other two chips (e.g., the RX chips) of the three chips 120. In further embodiments, it is contemplated that the touch panel 102 may implement more than three touch chips 120.

Embodiments of the touch panel assembly 100 of the present disclosure allow for the number of flexible printed circuit boards 132 connected to the touch panel 102 to be limited to one, with a few electrical connections 126 on the touch panel (e.g., glass) 102 itself.

Embodiments of the touch panel assembly 100 of the present disclosure can be implement in devices such as all-in-one computers, mobile computing devices (e.g., handheld portable computers, Personal Digital Assistants (PDAs), laptop computers, notebook computers, tablet computers, and so forth), mobile telephone devices (e.g., cellular telephones and smartphones), portable game devices, portable media players, multimedia devices, satellite navigation devices (e.g., Global Positioning System (GPS) navigation devices), e-book reader devices (eReaders), Smart Television (TV) devices, surface computing devices (e.g., table top computers), Personal Computer (PC) devices, and so forth.

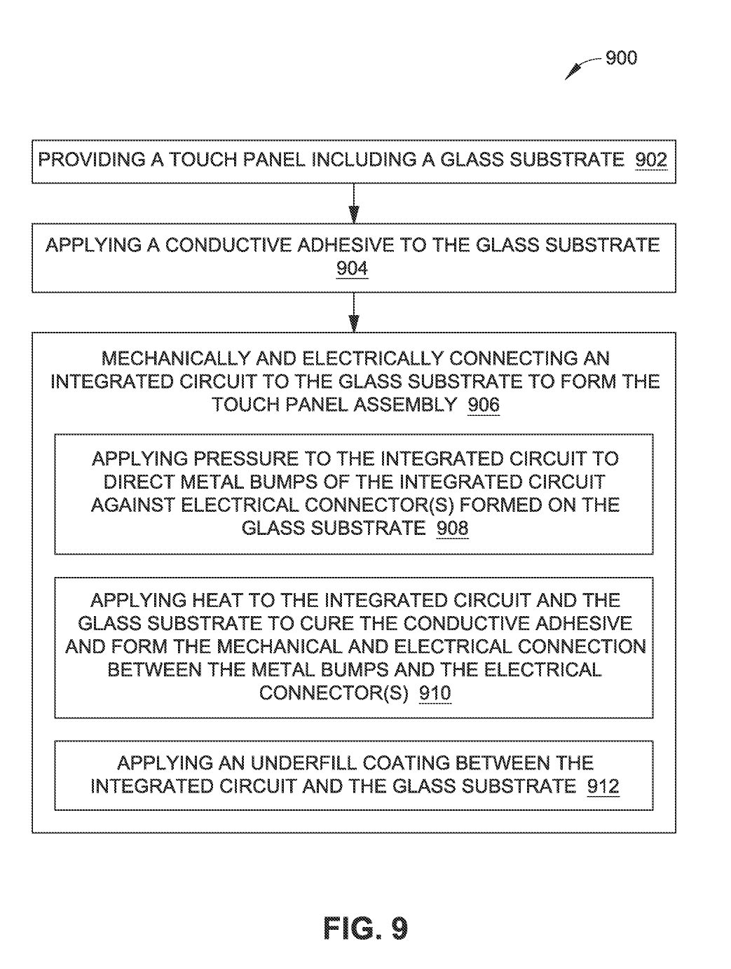

FIG. 9 depicts a flowchart illustrating an example process (e.g., method) for fabricating a touch panel assembly 100 in accordance with a further exemplary embodiment of the present disclosure. In embodiments, the process 900 includes a step of providing a touch panel including a glass substrate (Step 902). In embodiments, the process 900 includes a step of applying a conductive adhesive to the glass substrate of the touch panel (Step 904). For example, the conductive adhesive 128 can be Anisotropic Conductive Film (ACF). In embodiments, the process 900 includes a step of disposing an integrated circuit upon the conductive adhesive and the glass substrate to form the touch panel assembly (e.g., mechanically and electrically connecting an integrated circuit to the glass substrate of the touch panel to form the touch panel assembly; forming mechanical and electrical interconnects between the integrated circuit and the glass substrate) (Step 906). For example, the integrated circuit is a touch chip 120. In embodiments, the step of disposing an integrated circuit upon the conductive adhesive and the glass substrate to form the touch panel assembly includes the sub-step of directing connectors (e.g., bumps) of the integrated circuit against (e.g., into physical contact with) an electrical connector(s) formed on the glass substrate of the touch panel by applying pressure to the integrated circuit (Step 908). For example, the connectors of the integrated circuit are a plurality of gold bumps 122 and the electrical connector(s) is/are indium tin oxide (ITO) traces 126. In embodiments, the step of disposing an integrated circuit upon the conductive adhesive and the glass substrate to form the touch panel assembly further includes the sub-step of curing the conductive adhesive to form the mechanical and electrical connection between the connectors (e.g., bumps) on the integrated circuit and the electrical connector(s) formed on the glass substrate of the touch panel (Step 910). For example, with a thermoset adhesive, such as ACF, curing the adhesive is done by applying heat to the integrated circuit and the glass substrate of the touch panel. In embodiments, the step of disposing an integrated circuit upon the conductive adhesive and the glass substrate to form the touch panel assembly includes a step of applying an underfill (e.g., epoxy) coating between the integrated circuit and the glass substrate of the touch panel (Step 912).

### Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A method for fabricating a touch panel assembly, the method comprising:
providing a touch panel including a substrate having a plurality of electrical connectors formed on the substrate;
applying a conductive adhesive to the substrate; and
disposing an integrated circuit upon the conductive adhesive and the substrate to form the touch panel assembly,
wherein the electrical connectors are conductors.

2. The method as claimed in claim 1, wherein the step of disposing the integrated circuit upon the conductive adhesive and the substrate to form the touch panel assembly includes:
directing connectors of the integrated circuit against the electrical connectors formed on the substrate.

3. The method as claimed in claim 2, wherein the step of disposing the integrated circuit upon the conductive adhesive and the substrate to form the touch panel assembly includes:
curing the conductive adhesive to form a connection between the connectors of the integrated circuit and the electrical connectors formed on the substrate.

4. The method as claimed in claim 3, wherein the step of disposing the integrated circuit upon the conductive adhesive and the substrate to form the touch panel assembly includes:
applying an underfill coating between the integrated circuit and the substrate.

5. The method as claimed in claim 1, wherein the conductive adhesive is anisotropic conductive film.

6. The method as claimed in claim 1, wherein the integrated circuit is a touch chip.

7. The method as claimed in claim 1, wherein the electrical connectors formed on the substrate are indium tin oxide traces.

8. The method as claimed in claim 3, wherein curing the conductive adhesive is achieved by heating the substrate and the integrated circuit.

9. A touch panel assembly, comprising:
a touch panel, the touch panel including a substrate formed of insulator material, the touch panel including a plurality of conductors formed on the substrate; and
an integrated circuit, the integrated circuit being disposed upon the substrate and connected to one or more conductors included in the plurality of conductors, the integrated circuit configured for being communicatively coupled with the touch panel.

10. The touch panel assembly as claimed in claim 9, further comprising:
a printed circuit board; and
a flexible printed circuit board, the flexible printed circuit board connecting the printed circuit board to the touch panel and the integrated circuit.

11. The touch panel assembly as claimed in claim 10, further comprising:
a controller, the controller being communicatively coupled with the touch panel and the integrated circuit, the controller being configured for controlling the touch panel.

12. The touch panel assembly as claimed in claim 9, wherein the touch panel is a capacitive touch panel.

13. The touch panel assembly as claimed in claim 11, further comprising:
a display screen, the display screen being connected to the touch panel.

14. The touch panel assembly as claimed in claim 9, wherein the plurality of conductors are indium tin oxide traces.

15. The touch panel assembly as claimed in claim 9, wherein the substrate is formed of glass.

16. A touch panel assembly, comprising:
a touch panel, the touch panel including a substrate, the touch panel including a plurality of transparent conductors formed on the substrate;
an integrated circuit, the integrated circuit being disposed upon the substrate and bonded to one or more transparent conductors included in the plurality of transparent conductors via a conductive adhesive, the integrated circuit being communicatively coupled with the touch panel;
a display screen, the display screen being connected to the touch panel;
a printed circuit board, the printed circuit board being connected to the touch panel and the integrated circuit via a flexible printed circuit board; and
a controller, the controller being communicatively coupled with the touch panel and the integrated circuit, the controller being configured for controlling the touch panel.

17. The touch panel assembly as claimed in claim 16, wherein the controller is disposed upon the printed circuit board.

18. The touch panel assembly as claimed in claim 16, wherein the conductive adhesive is anisotropic conductive film.

19. The touch panel assembly as claimed in claim 16, wherein the plurality of transparent conductors are indium tin oxide traces.

20. The touch panel assembly as claimed in claim 16, wherein the integrated circuit is mechanically and electrically connected to the touch panel.
